(19) United States
(12) Patent Application Publication
(10) Pub. No.: US 2026/0017668 A1
(43) Pub. Date: Jan. 15, 2026

(54) SERVICE CALL TOPIC PREDICTION

(71) Applicant: Dell Products L.P., Round Rock, TX (US)

(72) Inventors: Yevgeni Gehtman, Modi'in (IL); Ophir Buchman, Raanana (IL); Omer Aharony, Kadima (IL)

(21) Appl. No.: 18/769,715

(22) Filed: Jul. 11, 2024

(51) Int. Cl. G06Q 30/015; H04L 41/5061

(52) U.S. Cl. CPC G06Q 30/015; H04L 41/5064

(57) ABSTRACT

A system can receive an indication regarding operation of a computer system. The system can identify a group of potential issues for the computer system. The system can rank potential issues of the group of potential issues based on respective frequencies of occurrence during a prior time period, to produce a first ranking. The system can revise the first ranking based on characteristics of the computer system, to produce a second ranking. The system can revise the second ranking based on metadata of the indication, to produce a third ranking. The system can present at least part of the third ranking via a user interface. The system can update how to rank potential issues based on feedback data received as input in response to the presenting.

### BACKGROUND

Computer systems can experience issues with their operations, which can be addressed through contacts to a service organization.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can receive an indication regarding operation of a computer system. The system can identify a group of potential issues for the computer system. The system can rank potential issues of the group of potential issues based on respective frequencies of occurrence during a prior time period, to produce a first ranking. The system can revise the first ranking based on characteristics of the computer system, to produce a second ranking. The system can revise the second ranking based on metadata of the indication, to produce a third ranking. The system can present at least part of the third ranking via a user interface. The system can update how to rank potential issues based on feedback data received as input in response to the presenting.

An example method can comprise identifying, by a system comprising at least one processor, a group of potential issues for computing equipment based on receiving an indication regarding operation of the computing equipment. The method can further comprise ranking, by the system, potential issues of the group of potential issues based on respective frequencies of occurrence during a prior time period, to produce a first ranking. The method can further comprise revising, by the system, the first ranking based on characteristics of the computing equipment, to produce a second ranking. The method can further comprise revising, by the system, the second ranking based on metadata of the indication, to produce a third ranking. The method can further comprise presenting, by the system, at least a part of the third ranking in a user interface. The method can further comprise updating, by the system, a process used to rank potential issues based on feedback data received in response to the presenting.

An example non-transitory computer-readable medium can comprise instructions that, in response to execution, cause a system comprising a processor to perform operations. These operations can comprise identifying a group of potential issues for a computing device based on receiving an indication regarding operation of the computing device. These operations can further comprise ranking potential issues of the group of potential issues based on respective frequencies of occurrence during a prior time period, based on characteristics of the computing device, and based on metadata of the indication, to produce a ranking. These operations can further comprise presenting at least a part of the ranking in a user interface. These operations can further comprise updating a technique for ranking potential issues based on feedback data received in response to the presenting.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate service call topic prediction, in accordance with an embodiment of this disclosure;

FIG. 2 illustrates an example process flow that can facilitate service call topic prediction, in accordance with an embodiment of this disclosure;

FIG. 3 illustrates another example system architecture that can facilitate service call topic prediction, in accordance with an embodiment of this disclosure;

FIG. 4 illustrates an example of a user interface that can facilitate service call topic prediction, in accordance with an embodiment of this disclosure;

FIG. 5 illustrates another example process flow that can facilitate service call topic prediction, in accordance with an embodiment of this disclosure;

FIG. 6 illustrates another example process flow that can facilitate service call topic prediction, in accordance with an embodiment of this disclosure;

FIG. 7 illustrates another example process flow that can facilitate service call topic prediction, in accordance with an embodiment of this disclosure;

FIG. 8 illustrates another example process flow that can facilitate service call topic prediction, in accordance with an embodiment of this disclosure;

FIG. 9 illustrates another example process flow that can facilitate service call topic prediction, in accordance with an embodiment of this disclosure;

FIG. 10 illustrates an example block diagram of a computer operable to execute an embodiment of this disclosure.

### DETAILED DESCRIPTION

### Overview

The present examples generally relate to phone calls to call centers. It can be appreciated that they can be applied to other scenarios, such as where a user seeks information about an issue with the user's computer system via online resources (e.g., text resources).

In the world of user support, understanding why users reach out can be pivotal for efficiently delivering service. The present techniques can facilitate a system that forecasts reasons behind user calls, leveraging database of user issues alongside similar characteristics, such as company size, company's environment, company's field-of-work, purchased devices, etc.

The system can predict the underlying issues prompting user inquiries by leveraging multiple data sources, historical call data, and contextual cues. A goal can be to enhance support representative efficiency, reduce call handling time, and improve overall user satisfaction.

Challenges that user representatives can face can include:
A broad variety of user issues can benefit from a streamlined approach to address them effectively;
Support representatives can often lack visibility into specific issues before engaging with users, leading to suboptimal interactions;
locating relevant information during issues can be a time-consuming process that hampers efficiency;
Identifying and performing an in-depth correlation of issues arriving from different users can be a time-consuming process.

There are prior approaches to forecasting topics that users call use support for. These prior approaches can include:
Machine Learning and Predictive Analytics: machine learning algorithms can be trained on historical user support data to predict the topics of incoming calls or messages. These models can learn from past interactions to classify new ones into relevant categories.
Topic Modeling: Topic modeling algorithms like Latent Dirichlet Allocation (LDA) or Non-Negative Matrix Factorization (NMF) can automatically identify topics within a corpus of user support interactions. These topics can then be used to classify new inquiries.
User Relationship Management (sometimes referred to as customer relationship management, CRM) Systems: CRM systems can offer features for tracking and categorizing user interactions. By utilizing the data within these systems, businesses can gain insights into common topics and trends among user inquiries.
Social Media Monitoring: Companies can monitor social media channels for user inquiries and feedback. Social media listening tools can analyze the content and sentiment of these messages to forecast emerging topics and trends.
Feedback and Survey Analysis: Analyzing feedback forms, user surveys, and post-interaction ratings can provide insights into the topics most frequently raised by users.

The present techniques can be implemented via a “Centralized Common-Shared Call Topic Prediction” (CCS-CTP) for expedited issue identification.

A call-topic-prediction-center can leverage a reduced-identification-process-pathway (derived from each user), and create a “ready-to-use-pathway” for other users.

Furthermore, the above ca be used for users that have similar characteristics, such as: company size, company's environment, company's field-of-work, purchased devices, etc.

Hence, the present techniques can be implemented to reduce Time-To-Response and Time-To-Resolution (TTRs), and increase a Quality of Service (QOS) via leveraging Cross-Users Call-Topics and concluded/recommended pathways, which can be determined by a cloud platform.

Consequently, the present techniques can be implemented to reduce various types of Confidentiality, Integrity, and Availability (CIA) impacts.

Information used to forecast a call's reason can be based on the following:
1. External data sources (news, weather forecasts, financial, etc.)
2. Internal data:
   a. Historical information about calls made to the data center
   b. A list of current product-specific hot issues
3. User-specific metadata:
   a. The phone call's metadata (caller ID, date/time, etc.)
   b. The user's environmental data (what products/services are installed, where they are installed, what features the user has, etc.)
   c. A list of issues raised by users with similar metadata (for correlation purposes)
4. User-specific call history:
   a. Historical information about calls made by this user
   b. A list of issues raised by users with a similar call history (for correlation purposes)
5. In examples where the call was made after the user filed an official support ticket, the above list can also include:
   a. The ticket's submitter
   b. The ticket's severity
   c. The product this ticket was opened against
   d. Topics/keywords this ticket includes
   e. The tone/sentiment of the text in the ticket

A process of choosing the relevant tickets to display can include the following steps. The steps are numbered here for clarity of an example, but there can be examples where this numbering is not implemented and/or not all of these steps are implemented.

In Step 1, start with a complete dataset of relevant issues. During this step, a system that implements the present techniques can attempt to determine what issues may be relevant to this user based on the devices they have installed onsite. This list can be large, such as where a ticket was opened before this call. It can be that the system can narrow the list to issues that are relevant to a specific product.

The generated list can contain “all available issues this user may be calling about”.

Once the list is generated, the following steps can involve ranking the issues based on their likelihood of being the reason for the call.

In Step 2, prioritize relevant issues based on general case history. During this step, a system that implements the present techniques can attempt to rank the items in the list by determining the “hottest” issues. The hottest issues can be issues that have been sighted lately and repeated more than others.

For example, this can involve querying the reoccurrence of an issue in the last month and rank issues that had a higher “Reoccurrence Rate”.

This information can be cached to expedite this step for similar future queries.

In Step 3, prioritize relevant issues based on the user's environment. During this step, a system that implements the present techniques can attempt to rank the items in the list by determining which issues are more likely relevant for this user.

Some examples of Step 3 can include:
If the user has a single product in its environment, replication-related issues can be ranked lower as they can be less relevant for this user's consumption model.
If the user calls occur during business hours and the user's production systems are sensitive to performance metrics, issues regarding performance issues can be ranked higher.
If the user just upgraded their system a short time ago, issues that are related to post-upgrade system behaviors can be ranked higher.
If the user has frequent issues related to a specific feature or component, issues that have related characteristics can be ranked higher.
If other users with similar environment characteristics reported a specific issue, that issue can be ranked higher.

If a ticket was opened before this call, then the system can rank the issue list more accurately by using keywords/topics identified in the issue description.

In Step 4, prioritize relevant issues based on the call's metadata. During this step, the system can attempt to rank the items in the list by determining which issues are more likely relevant for this user during this specific call.

Some examples of Step 4 can include:
If the user is located in Florida and the call is made during a hurricane season, issues related to power outages can be ranked higher.
If the call was made during non-business hours, issues related to high-severity and high-impact cases can be ranked higher.

In some examples, if a ticket was opened before this call, the system can rank the issue list more accurately based on:
Sentiment and severity: If the sentiment of the issue's description is calm and does not display signs of stress, it can be determined that the issue is unlikely to be severe.
The case submitter: If an organization's chief executive officer (CEO) reported this issue, it can be determined that this is most likely a high-impact issue. High-severity and high-impact cases can be ranked higher.

In Step 5, display a list of highly-ranked cases. During this step, the system can create a list of the most likely reasons for the user's call based on the issues with the highest ranking. This list can be displayed to the support agent, which can leverage the list during their call.

In Step 6, a support agent can provide feedback. During this step, the support agent can provide feedback on whether the call topic was predicted accurately. In case it was not, the support agent can provide a reference to the actual issue this user called about.

This information can be leveraged to create a future correlation between users with similar environments and the issues encountered.

A process of correlating issues based on agent feedback can be performed as follows.

A CCS-TTP database can be trained. Training can be performed based on support agents' feedback with previous user engagements. A CCS-TTP can map an issue to a user's characteristics, such as: company size, company's environment, company's field-of-work, dell purchased devices, etc.

Querying the CCS-TTP database upon user engagement can be performed based on their specific characteristics, where the system can provide a list of issues prioritized by their relevancy.

Common query responses can be cached and leveraged for future usage to increase user satisfaction and shorten response times.

The present techniques can facilitate a reduction of CIA impact via use of a Centralized Common-Shared Call Topic Prediction component for expedited issue identification via a cloud platform. The present techniques can facilitate an in-depth enhancement of operational efficiency through proactive user call topic prediction for expedited issue identification.

Implementing the present techniques can offer the following benefits relative to prior approaches. That is, implementing the present techniques to facilitate forecasting the topic a user is calling about before a user support call can significantly enhance user experience in several ways:
Faster resolution times: By predicting the topic of the user's inquiry beforehand, user support agents can be better prepared to address the issue promptly. This can reduce the time users spend on hold or waiting for a resolution, leading to a more efficient and satisfactory experience.
Personalized service: Anticipating the user's needs can allow support agents to tailor their responses and recommendations accordingly. This personalized approach can demonstrate attentiveness and empathy, enhancing the overall user experience.
Reduced user effort: Users can find it frustrating to explain their issue repeatedly or navigate through automated phone menus to reach the appropriate support channel. Predicting the topic of their inquiry can minimize users' need to provide extensive details, thereby reducing their effort and frustration.
Improved first-contact resolution: When support agents are equipped with insights into the expected topic of the call, they can be more likely to resolve the issue during the initial interaction. This can reduce the need for follow-up calls or escalations, leading to greater user satisfaction.

Prior approaches generally use various user properties to predict which users will soon call into a call center, and why. With the present techniques, a database can be implemented that leverages historical call information in addition to other information to predict a call reason. This other information can include product type, product version, hardware and software configuration, and data related to external data sources (e.g., weather, internet service provider (ISP) disconnections).

An entry in such a “CCS-CTP” database can comprise user properties (e.g., what relevant properties this user has that are relevant for this issue, and can be common to other users as well), case identified (the issue that was actually identified), working resolution (what solution worked for this user), and a reference number to track the number of occurrences (such as to identify a thread).

With this information in the database, when other users with common properties call in to a call enter, relevant entries in the database can be used to help prioritize relevant cases.

In accordance with the present techniques, a weather-related data source can provide information about weather events (e.g., an active hurricane), and can be useful in prioritizing shutdown or replication-related issues. A power-related data source can inform about known power outages and can be useful in prioritizing issues related to service disruptions following an unexpected power outage. A communication-related data source can inform about ISP disconnections and can be useful in prioritizing issues related to replication failures.

The present techniques can be implemented to generate a list of the top N reasons predicted for why a user is calling. In an example, users with specific properties can often call about issue A, and can sometimes call about Issues B and/or C. The present techniques can be implemented whereby self-adaptation is performed, and Issues A, B, and C can be presented as a call prediction result.

The present techniques can generally be applied to a “pre-call” phase, which can be viewed in contrast to approaches that focus on “mid-call” and “post-call” phases. Additionally, the present techniques can be implemented to facilitate using a resolution's commonality to other user issues to identify resolutions with those issues. The present techniques can be implemented to diminish a time-to-resolution for a user issue, which can elevate a user's overall satisfaction.

### Example Architectures, Etc.

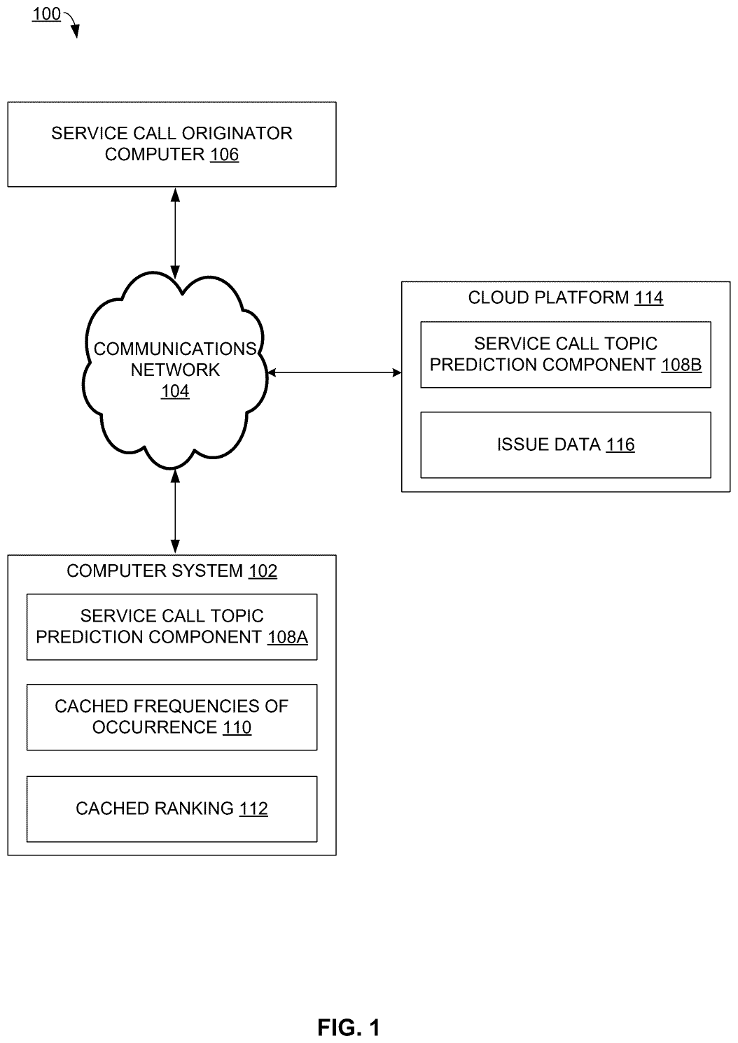

FIG. 1 illustrates an example system architecture 100 that can facilitate service call topic prediction, in accordance with an embodiment of this disclosure.

System architecture 100 comprises computer system 102, communications network 104, service call originator computer 106, and cloud platform 114. In turn computer system 102 comprises service call topic prediction component 108A, cached frequencies of occurrence 110, and cached ranking 112. And cloud platform 114 comprises service call topic prediction component 108B and issue data 116.

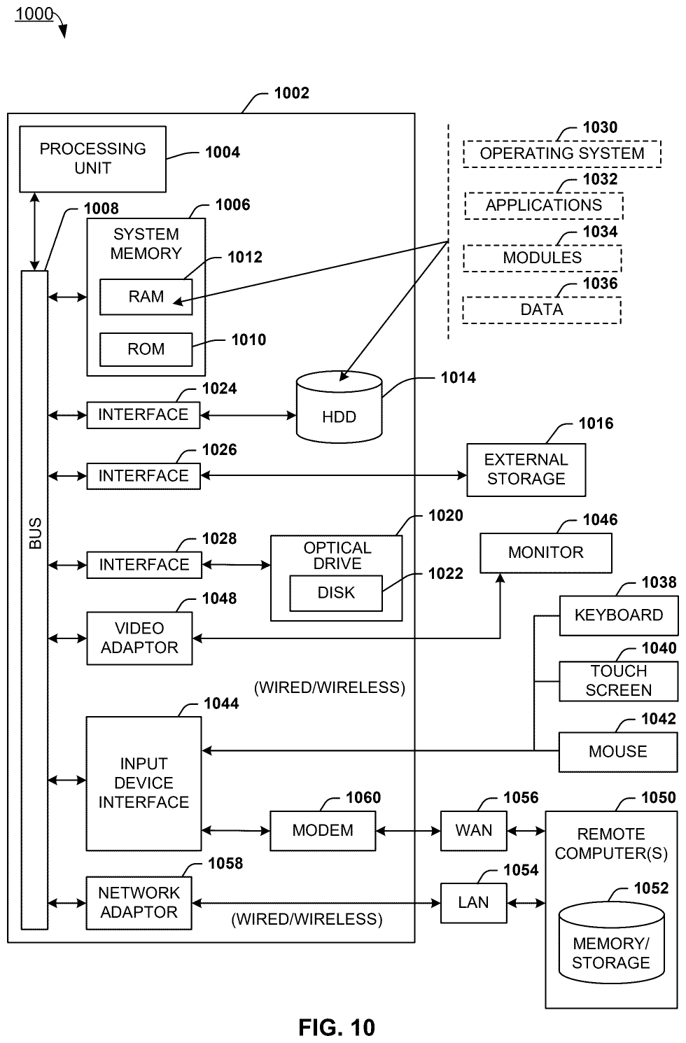

Each of computer system 102, service call originator computer 106, and/or cloud platform 114 can be implemented with part(s) of computing environment 1000 of FIG. 10. Communications network 104 can comprise a computer communications network, such as the Internet, or an isolated private computer communications network.

A service call can be originated at service call originator computer 106. Cloud platform 114 can utilize issue data 116 to identify a ranking of likely issues for the service call, and provide this information to computer system 102 for display in a user interface. Computer system 102 can cache certain information such as cached frequencies of occurrence 110 (of issues) and cached ranking 112 (of issues) to expedite displaying a ranking.

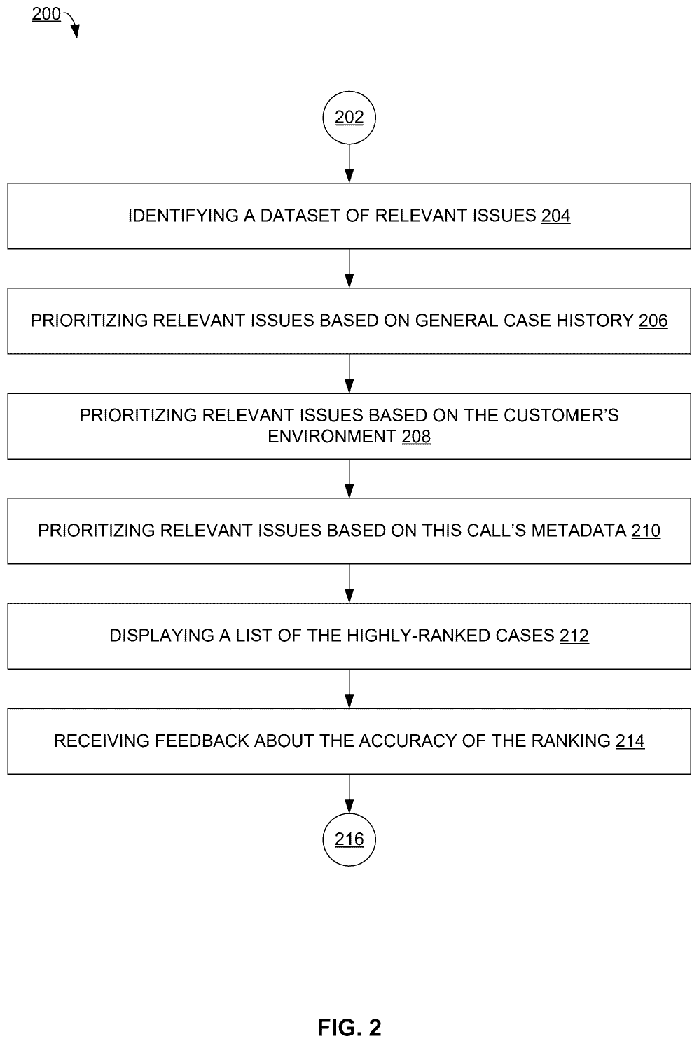

In some examples, service call topic prediction component 108A and/or service call topic prediction component 108B can implement part(s) of the process flows of FIGS. 2 and/or 7-9 to facilitate service call topic prediction.

It can be appreciated that system architecture 100 is one example system architecture for service call topic prediction, and that there can be other system architectures that facilitate service call topic prediction.

FIG. 2 illustrates an example process flow that can facilitate service call topic prediction, in accordance with an embodiment of this disclosure. In some examples, one or more embodiments of process flow 200 can be implemented by system architecture 100 of FIG. 1, or computing environment 1000 of FIG. 10.

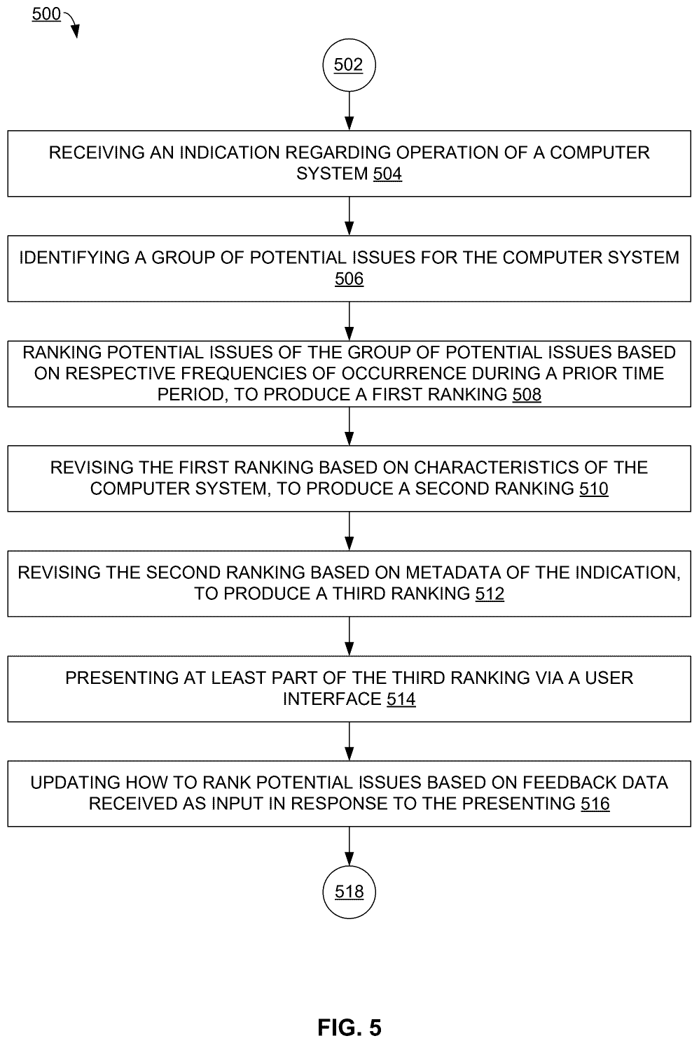

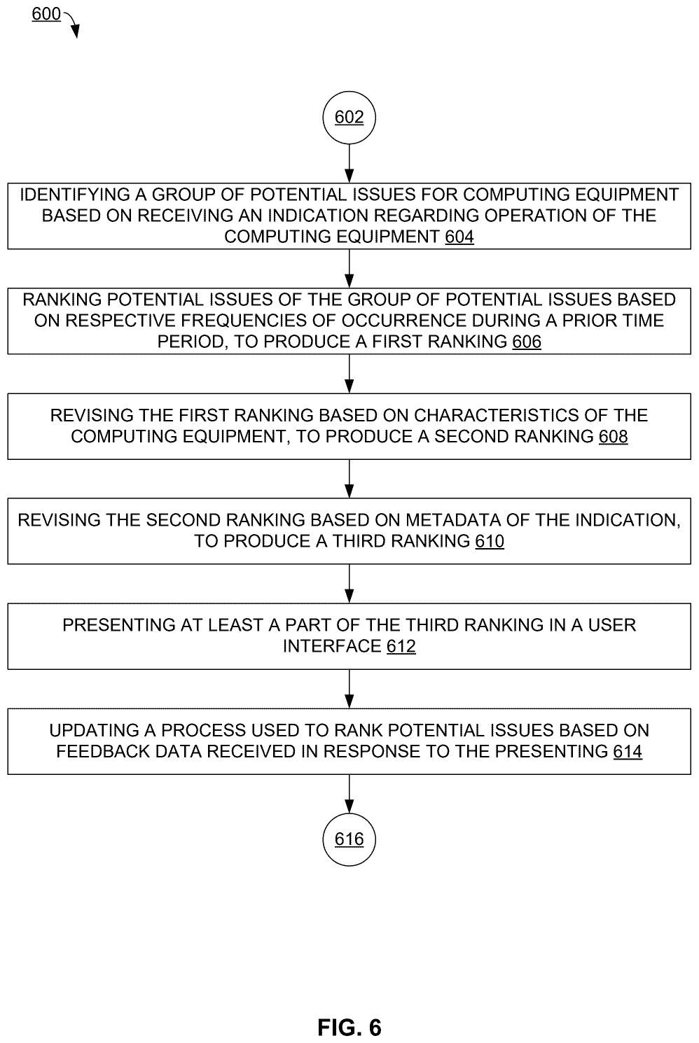

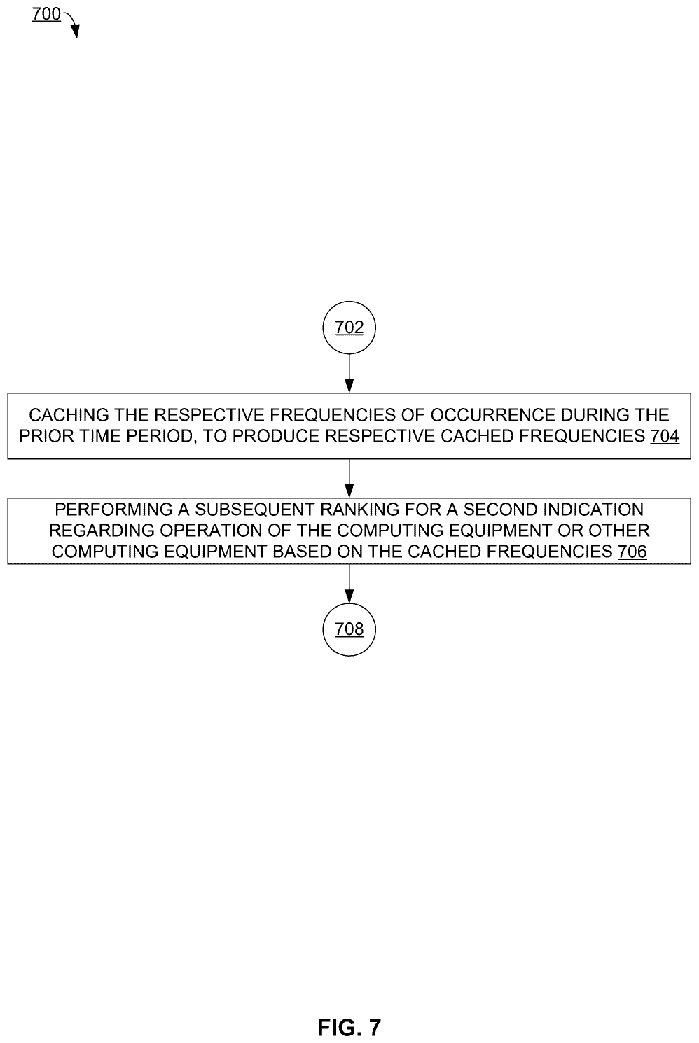

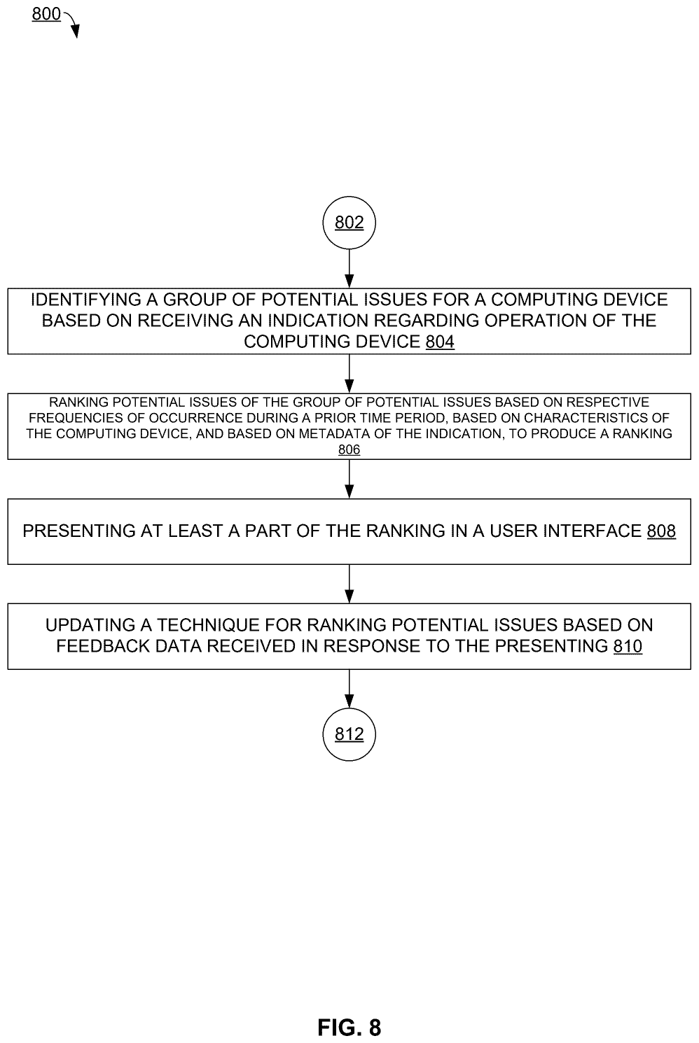

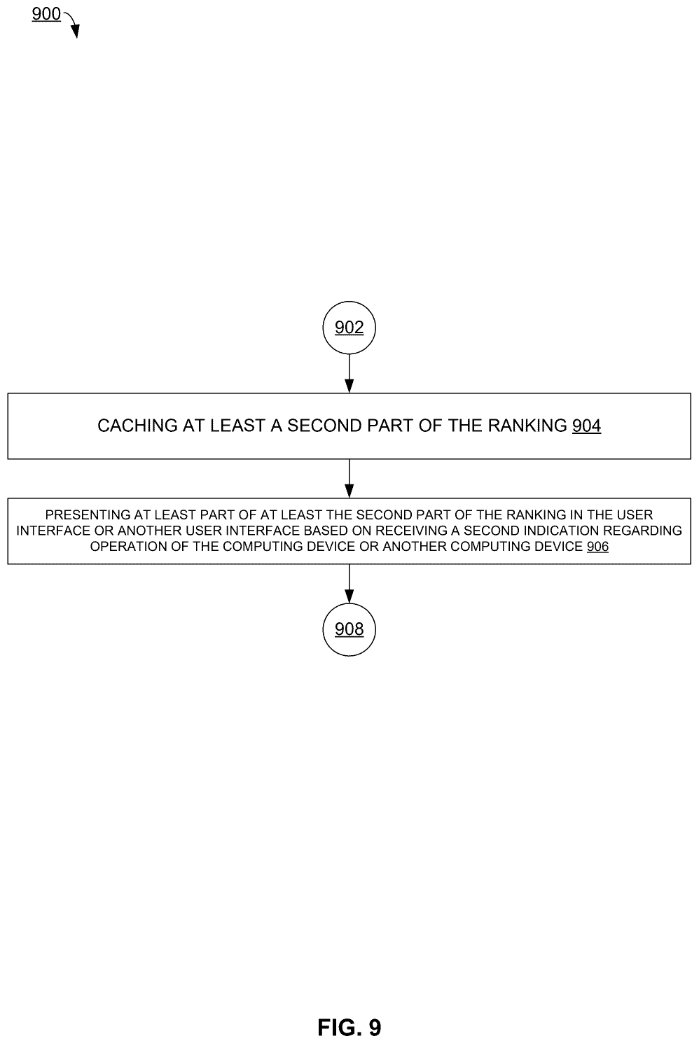

It can be appreciated that the operating procedures of process flow 200 are example operating procedures, and that there can be embodiments that implement more or fewer operating procedures than are depicted, or that implement the depicted operating procedures in a different order than as depicted. In some examples, process flow 200 can be implemented in conjunction with one or more embodiments of one or more of process flow 500 of FIG. 5, process flow 600 of FIG. 6, process flow 700 of FIG. 7, process flow 800 of FIG. 8, and/or process flow 900 of FIG. 9.

Process flow 200 begins with 202, and moves to operation 204.

Operation 204 depicts identifying a dataset of relevant issues.

After operation 204, process flow 200 moves to operation 206.

Operation 206 depicts prioritizing relevant issues based on general case history.

After operation 206, process flow 200 moves to operation 208.

Operation 208 depicts prioritizing relevant issues based on the customer's environment.

After operation 208, process flow 200 moves to operation 210.

Operation 210 depicts prioritizing relevant issues based on this call's metadata.

After operation 210, process flow 200 moves to operation 212.

Operation 212 depicts displaying a list of the highly-ranked cases.

After operation 212, process flow 200 moves to operation 214.

Operation 214 depicts receiving feedback about the accuracy of the ranking.

After operation 214, process flow 200 moves to 216, where process flow 200 ends.

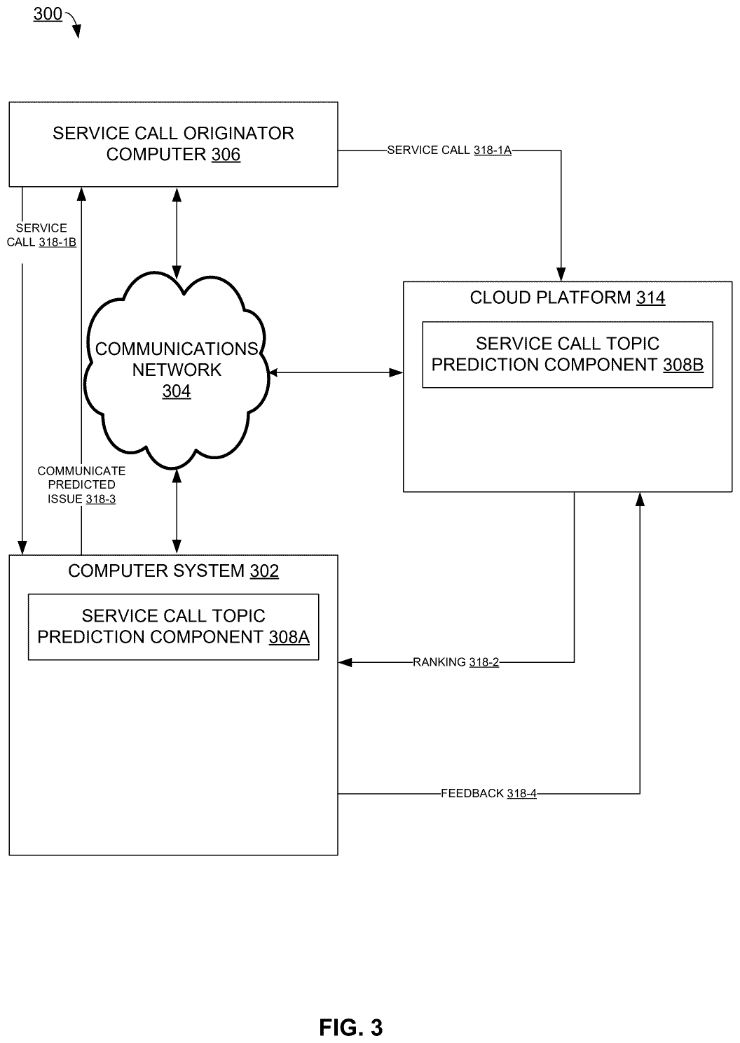

FIG. 3 illustrates another example system architecture 300 that can facilitate service call topic prediction, in accordance with an embodiment of this disclosure. In some examples, part(s) of system architecture 300 can be implemented by part(s) of system architecture 100 of FIG. 1 to facilitate service call topic prediction.

System architecture 300 comprises computer system 302, communications network 304, service call originator computer 306, and cloud platform 314 (which can be similar to computer system 102, communications network 104, service call originator computer 106, and cloud platform 114 of FIG. 1, respectively). Between these components, various communications can be made to effectuate service call topic prediction, such as in this order:
1. 318-1A and 318-1B: a service call is made that originates at service call originator computer 306 and is received by computer system 302 and cloud platform 314;
2. 318-2: cloud platform 314 can provide computer system 302 with a ranking of possible issues that relate to the service call;
3. 318-3: at least one of the issues of the ranking is communicated by computer system 302 to service call originator computer 306, and service call originator computer 306 provides an indication of whether that is the correct issue;
4. 318-4: computer system 302 provides feedback (e.g., whether the issue was correctly identified by the ranking) about the ranking to cloud platform 314, which can update its approach to ranking based on this feedback.

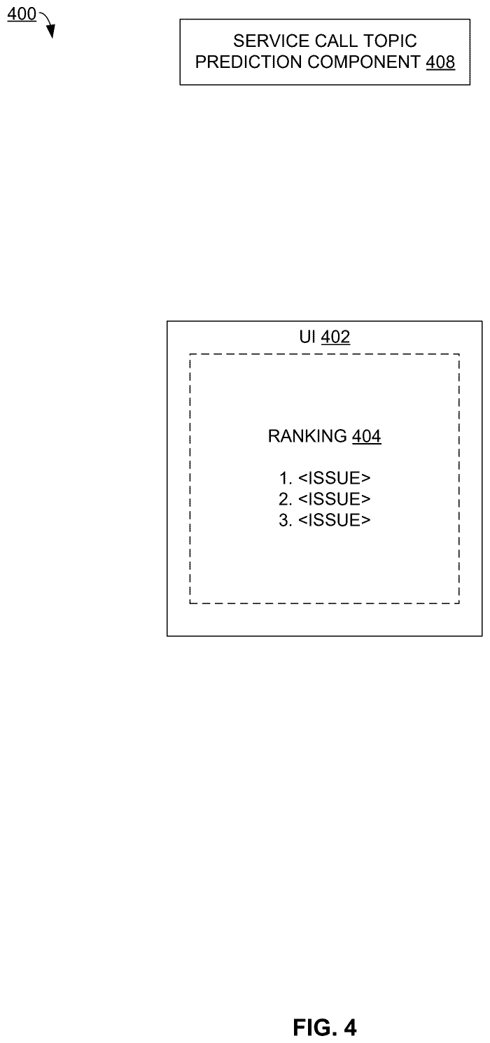

FIG. 4 illustrates an example 400 of a user interface that can facilitate service call topic prediction, in accordance with an embodiment of this disclosure. In some examples, part(s) of example 400 can be implemented by part(s) of system architecture 100 of FIG. 1 to facilitate service call topic prediction.

Example 400 comprises user interface (UI) 402, ranking 404, and service call topic prediction component 408 (which can be similar to service call topic prediction component 108A of FIG. 1). Using the example of FIG. 1, UI 402 can be a UI displayed by computer system 102. UI 402 comprises ranking 404, which can be a ranking of potential issues with a computer for which a service call is being made.

Ranking 404 can comprise a subset of identified and ranked issues. For example, where 10 issues were identified and ranked, ranking 404 can comprise displayed the top three most-likely issues.

### Example Process Flows

FIG. 5 illustrates an example process flow that can facilitate service call topic prediction, in accordance with an embodiment of this disclosure. In some examples, one or more embodiments of process flow 500 can be implemented by system architecture 100 of FIG. 1, or computing environment 1000 of FIG. 10.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 200 of FIG. 2, process flow 600 of FIG. 6, process flow 700 of FIG. 7, process flow 800 of FIG. 8, and/or process flow 900 of FIG. 9.

Process flow 500 begins with 502, and moves to operation 504.

Operation 504 depicts receiving an indication regarding operation of a computer system.

After operation 504, process flow 500 moves to operation 506. This can comprise receiving a contact about service for a computer, such as a voice call or a text chat.

Operation 506 depicts identifying a group of potential issues for the computer system. This can be performed in a similar manner to Step 1, as described herein.

In some examples, the identifying of the group of potential issues for the computer system is performed based on installed devices of the computer system. In some examples, the identifying of the group of potential issues for the computer system is performed based on a support ticket that identifies a product of the computer system. This can be performed in a similar manner as described with respect to Step 1.

After operation 506, process flow 500 moves to operation 508.

Operation 508 depicts ranking potential issues of the group of potential issues based on respective frequencies of occurrence during a prior time period, to produce a first ranking. This can be performed in a similar manner to Step 2, as described herein.

In some examples, the first ranking is based on historical information about indications regarding operation of computer systems, or current product-specific hot issues. That is, information from a vendor can be used to forecast a reason for the contact.

After operation 508, process flow 500 moves to operation 510.

Operation 510 depicts revising the first ranking based on characteristics of the computer system, to produce a second ranking. This can be performed in a similar manner to Step 3, as described herein.

After operation 510, process flow 500 moves to operation 512.

Operation 512 depicts revising the second ranking based on metadata of the indication, to produce a third ranking. This can be performed in a similar manner to Step 4, as described herein.

In some examples, the metadata of the indication is determined from an external news data source, an external weather forecast data source, or an external financial data source. That is, external data sources can be used to forecast a reason for the contact.

In some examples, the metadata of the indication comprises phone call metadata, environmental data of a user account associated with the computer system, or issues raised by user accounts with similar metadata as the user account according to a defined metadata similarity criterion. That is, user-specific metadata can be used to forecast a reason for the contact.

In some examples, the indication is a first indication, the first indication regarding operation of the computer system is associated with a first user account, and the metadata of the indication comprises historical information about a previous indication regarding operation of the computer system or another computer system that is associated with the first user account, or issues raised in second indications that are associated with second user accounts that have a similar history of communication as the first user account according to a defined communication history similarity criterion. That is, user-specific contact information can be used to forecast a reason for the contact.

In some examples, the indication is a first indication, the first indication is received subsequent to a corresponding support ticket being filed, and the metadata comprises a second indication of an entity that submitted the support ticket, a severity of the support ticket, a product associated with the support ticket, a topic or keyword associated with the support ticket, or a tone or sentiment associated with text of the support ticket. That is, information about a previously-filed support ticket from a user that initiated the contact can be used to forecast a reason for the contact.

After operation 512, process flow 500 moves to operation 514.

Operation 514 depicts presenting at least part of the third ranking via a user interface. This can be performed in a similar manner to Step 5, as described herein. After operation 514, process flow 500 moves to operation 516.

Operation 516 depicts updating how to rank potential issues based on feedback data received as input in response to the presenting. This can be performed in a similar manner to Step 6, as described herein.

After operation 516, process flow 500 moves to 518, where process flow 500 ends.

FIG. 6 illustrates an example process flow that can facilitate service call topic prediction, in accordance with an embodiment of this disclosure. In some examples, one or more embodiments of process flow 600 can be implemented by system architecture 100 of FIG. 1, or computing environment 1000 of FIG. 10.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 200 of FIG. 2, process flow 500 of FIG. 5, process flow 700 of FIG. 7, process flow 800 of FIG. 8, and/or process flow 900 of FIG. 9.

Process flow 600 begins with 602, and moves to operation 604.

Operation 604 depicts identifying a group of potential issues for computing equipment based on receiving an indication regarding operation of the computing equipment. In some examples, operation 604 can be implemented in a similar manner as operations 504-506 of FIG. 5.

After operation 604, process flow 600 moves to operation 606.

Operation 606 depicts ranking potential issues of the group of potential issues based on respective frequencies of occurrence during a prior time period, to produce a first ranking. In some examples, operation 606 can be implemented in a similar manner as operation 508 of FIG. 5.

After operation 606, process flow 600 moves to operation 608.

Operation 608 depicts revising the first ranking based on characteristics of the computing equipment, to produce a second ranking. In some examples, operation 608 can be implemented in a similar manner as operation 510 of FIG. 5.

In some examples, the revising of the first ranking based on the characteristics of the computing equipment, to produce a second ranking comprises revising the first ranking based on aa number of products in the computing equipment, a time of day at which the indication was received, a date at which the computing equipment was upgraded, or a history of issues with a component of the computing equipment.

After operation 608, process flow 600 moves to operation 610.

Operation 610 depicts revising the second ranking based on metadata of the indication, to produce a third ranking. In some examples, operation 610 can be implemented in a similar manner as operation 512 of FIG. 5.

In some examples, the revising of the second ranking based on the metadata of the indication comprises revising the second ranking based on a physical location of the computing equipment, a time of day at which the indication was received, or an importance of a user account associated with the indication.

After operation 610, process flow 600 moves to operation 612.

Operation 612 depicts presenting at least a part of the third ranking in a user interface. In some examples, operation 612 can be implemented in a similar manner as operation 514 of FIG. 5.

In some examples, at least the part of the third ranking comprises a portion of the third ranking that has a highest ranking of the third ranking.

After operation 612, process flow 600 moves to operation 614.

Operation 614 depicts updating a process used to rank potential issues based on feedback data received in response to the presenting. In some examples, operation 614 can be implemented in a similar manner as operation 516 of FIG. 5.

In some examples, the feedback data indicates whether at least the part of the third ranking correctly identified an issue with the computing equipment.

After operation 614, process flow 600 moves to 616, where process flow 600 ends.

FIG. 7 illustrates an example process flow that can facilitate service call topic prediction, in accordance with an embodiment of this disclosure. In some examples, one or more embodiments of process flow 700 can be implemented by system architecture 100 of FIG. 1, or computing environment 1000 of FIG. 10.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 200 of FIG. 2, process flow 500 of FIG. 5, process flow 600 of FIG. 6, process flow 800 of FIG. 8, and/or process flow 900 of FIG. 9.

Process flow 700 begins with 702, and moves to operation 704.

Operation 704 depicts caching the respective frequencies of occurrence during the prior time period, to produce respective cached frequencies. Where frequencies of occurrence of issues are used to produce a ranking, this information can be cached (using the example of FIG. 1, cither by computer system 102 and/or cloud platform 114) for use in producing a future ranking.

After operation 704, process flow 700 moves to operation 706.

Operation 706 depicts performing a subsequent ranking for a second indication regarding operation of the computing equipment or other computing equipment based on the cached frequencies. In some examples, a future ranking can be determined based on the cached frequencies of occurrence, rather than re-determining the frequencies of occurrence from source data.

After operation 706, process flow 700 moves to 708, where process flow 700 ends.

FIG. 8 illustrates an example process flow that can facilitate service call topic prediction, in accordance with an embodiment of this disclosure. In some examples, one or more embodiments of process flow 800 can be implemented by system architecture 100 of FIG. 1, or computing environment 1000 of FIG. 10.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 200 of FIG. 2, process flow 500 of FIG. 5, process flow 600 of FIG. 6, process flow 700 of FIG. 7, and/or process flow 900 of FIG. 9.

Process flow 800 begins with 802, and moves to operation 804.

Operation 804 depicts identifying a group of potential issues for a computing device based on receiving an indication regarding operation of the computing device. In some examples, operation 804 can be implemented in a similar manner as operations 504-506 of FIG. 5.

In some examples, the indication is expressed via a support call or a support chat.

After operation 804, process flow 800 moves to operation 806.

Operation 806 depicts ranking potential issues of the group of potential issues based on respective frequencies of occurrence during a prior time period, based on characteristics of the computing device, and based on metadata of the indication, to produce a ranking. In some examples, operation 806 can be implemented in a similar manner as operations 508-512 of FIG. 5.

After operation 806, process flow 800 moves to operation 808.

Operation 808 depicts presenting at least a part of the ranking in a user interface. In some examples, operation 808 can be implemented in a similar manner as operation 514 of FIG. 5.

After operation 808, process flow 800 moves to operation 810.

Operation 810 depicts updating a technique for ranking potential issues based on feedback data received in response to the presenting. In some examples, operation 810 can be implemented in a similar manner as operation 516 of FIG. 5.

In some examples, the characteristics are first characteristics, and the updating of the technique for ranking potential issues based on the feedback data received in response to the presenting comprises mapping issues with computing devices to second characteristics of user accounts.

In some examples, the characteristics of the user accounts comprise respective numbers of employees associated with respective user accounts of the user accounts, respective environments associated with the respective user accounts, respective lines of business associated with the respective user accounts, or respective devices acquired from an entity associated with the system that are possessed by the respective user accounts.

In some examples, the identifying, the ranking, and the updating are performed using cloud computing equipment of a cloud computing platform.

After operation 810, process flow 800 moves to 812, where process flow 800 ends.

FIG. 9 illustrates an example process flow that can facilitate service call topic prediction, in accordance with an embodiment of this disclosure. In some examples, one or more embodiments of process flow 900 can be implemented by system architecture 100 of FIG. 1, or computing environment 1000 of FIG. 10.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 200 of FIG. 2, process flow 500 of FIG. 5, process flow 600 of FIG. 6, process flow 700 of FIG. 7, and/or process flow 800 of FIG. 8.

Process flow 900 begins with 902, and moves to operation 904.

Operation 904 depicts caching at least a second part of the ranking. In some examples, a ranking can be cached (using the example of FIG. 1, either by computer system 102 and/or cloud platform 114) for use in presenting that ranking again where a similar service call is received.

After operation 904, process flow 900 moves to operation 906.

Operation 906 depicts presenting at least part of at least the second part of the ranking in the user interface or another user interface based on receiving a second indication regarding operation of the computing device or another computing device. That is, a cached ranking can be used in addressing a future service call rather than regenerating a ranking anew.

After operation 906, process flow 900 moves to 908, where process flow 900 ends.

### Example Operating Environment

In order to provide additional context for various embodiments described herein, FIG. 10 and the following discussion are intended to provide a brief, general description of a suitable computing environment 1000 in which the various embodiments of the embodiment described herein can be implemented.

For example, parts of computing environment 1000 can be used to implement one or more embodiments of computer system 102, service call originator computer 106, and/or cloud platform 114 of FIG. 1.

In some examples, computing environment 1000 can implement one or more embodiments of the process flows of FIGS. 2 and/or 7-9 to facilitate service call topic prediction.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per sc.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a nonvolatile storage such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples, and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1016 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
receiving an indication regarding operation of a computer system;
identifying a group of potential issues for the computer system;
ranking potential issues of the group of potential issues based on respective frequencies of occurrence during a prior time period, to produce a first ranking;
revising the first ranking based on characteristics of the computer system, to produce a second ranking;
revising the second ranking based on metadata of the indication, to produce a third ranking;
presenting at least part of the third ranking via a user interface; and
updating how to rank potential issues based on feedback data received as input in response to the presenting.

2. The system of claim 1, wherein the metadata of the indication is determined from an external news data source, an external weather forecast data source, or an external financial data source.

3. The system of claim 1, wherein the first ranking is based on historical information about indications regarding operation of computer systems, or current product-specific hot issues.

4. The system of claim 1, wherein the metadata of the indication comprises phone call metadata, environmental data of a user account associated with the computer system, or issues raised by user accounts with similar metadata as the user account according to a defined metadata similarity criterion.

5. The system of claim 1, wherein the indication is a first indication, wherein the first indication regarding operation of the computer system is associated with a first user account, and wherein the metadata of the indication comprises historical information about a previous indication regarding operation of the computer system or another computer system that is associated with the first user account, or issues raised in second indications that are associated with second user accounts that have a similar history of communication as the first user account according to a defined communication history similarity criterion.

6. The system of claim 1, wherein the indication is a first indication, wherein the first indication is received subsequent to a corresponding support ticket being filed, and wherein the metadata comprises a second indication of an entity that submitted the support ticket, a severity of the support ticket, a product associated with the support ticket, a topic or keyword associated with the support ticket, or a tone or sentiment associated with text of the support ticket.

7. The system of claim 1, wherein the identifying of the group of potential issues for the computer system is performed based on installed devices of the computer system.

8. The system of claim 1, wherein the identifying of the group of potential issues for the computer system is performed based on a support ticket that identifies a product of the computer system.

9. A method, comprising:
identifying, by a system comprising at least one processor, a group of potential issues for computing equipment based on receiving an indication regarding operation of the computing equipment;
ranking, by the system, potential issues of the group of potential issues based on respective frequencies of occurrence during a prior time period, to produce a first ranking;
revising, by the system, the first ranking based on characteristics of the computing equipment, to produce a second ranking;
revising, by the system, the second ranking based on metadata of the indication, to produce a third ranking;
presenting, by the system, at least a part of the third ranking in a user interface; and
updating, by the system, a process used to rank potential issues based on feedback data received in response to the presenting.

10. The method of claim 9, further comprising:
caching, by the system, the respective frequencies of occurrence during the prior time period, to produce respective cached frequencies; and
performing, by the system, a subsequent ranking for a second indication regarding operation of the computing equipment or other computing equipment based on the cached frequencies.

11. The method of claim 9, wherein the revising of the first ranking based on the characteristics of the computing equipment, to produce a second ranking comprises:
revising the first ranking based on aa number of products in the computing equipment, a time of day at which the indication was received, a date at which the computing equipment was upgraded, or a history of issues with a component of the computing equipment.

12. The method of claim 9, wherein the revising of the second ranking based on the metadata of the indication comprises:
revising the second ranking based on a physical location of the computing equipment, a time of day at which the indication was received, or an importance of a user account associated with the indication.

13. The method of claim 9, wherein at least the part of the third ranking comprises a portion of the third ranking that has a highest ranking of the third ranking.

14. The method of claim 9, wherein the feedback data indicates whether at least the part of the third ranking correctly identified an issue with the computing equipment.

15. A non-transitory computer-readable medium comprising instructions that, in response to execution, cause a system comprising at least one processor to perform operations, comprising:
identifying a group of potential issues for a computing device based on receiving an indication regarding operation of the computing device;
ranking potential issues of the group of potential issues based on respective frequencies of occurrence during a prior time period, based on characteristics of the computing device, and based on metadata of the indication, to produce a ranking;
presenting at least a part of the ranking in a user interface; and
updating a technique for ranking potential issues based on feedback data received in response to the presenting.

16. The non-transitory computer-readable medium of claim 15, wherein the indication is expressed via a support call or a support chat.

17. The non-transitory computer-readable medium of claim 15, wherein the characteristics are first characteristics, and wherein the updating of the technique for ranking potential issues based on the feedback data received in response to the presenting comprises:
mapping issues with computing devices to second characteristics of user accounts.

18. The non-transitory computer-readable medium of claim 17, wherein the characteristics of the user accounts comprise respective numbers of employees associated with respective user accounts of the user accounts, respective environments associated with the respective user accounts, respective lines of business associated with the respective user accounts, or respective devices acquired from an entity associated with the system that are possessed by the respective user accounts.

19. The non-transitory computer-readable medium of claim 15, wherein at least the part of the ranking is at least a first part of the ranking, and wherein the operations further comprise:
caching at least a second part of the ranking; and
presenting at least part of at least the second part of the ranking in the user interface or another user interface based on receiving a second indication regarding operation of the computing device or another computing device.

20. The non-transitory computer-readable medium of claim 15, wherein the identifying, the ranking, and the updating are performed using cloud computing equipment of a cloud computing platform.
